(19) United States
(12) Patent Application Publication
(10) Pub. No.: US 2013/0145909 A1
(43) Pub. Date: Jun. 13, 2013

(54) Grip for a Tool Handle

(71) Applicant: William Rogers, Bryan, TX (US)

(72) Inventor: William Rogers, Bryan, TX (US)

(21) Appl. No.: 13/324,163

(22) Filed: Dec. 13, 2011

(51) Int. Cl. B25G 1/10; B25G 1/00

(52) U.S. Cl. 81/492; 81/489

(57) ABSTRACT

Provided herein is an ergonomic device for gripping a tool handle and an assembly comprising the tool handle grip and the tool handle. The ergonomic device comprises, on an elongate gripping body,means for receiving a gripping end of a tool handle and means for gripping the tool handle. Particularly, the elongate body has a receiving end, a knob gripping end and a gripping portion disposed there between. The gripping portion forms an inclined S-like curved shape with the receiving end and a knob gripping end and comprises in an ergonomic disposition a raised thumb grip, side grips and a plurality of finger grooves.

### BACKGROUND OF THE INVENTION

1. Field of the Invention

The present invention relates generally to the field of tool handles with grips for lawn, garden and construction tools. More specifically, the present invention relates to an ergonomic handheld grip for a tool handle having a curved gripping configuration for easier and more comfortable gripping and manipulation.

2. Description of the Related Art

Commonly, tool handles for tool heads, such as for shovels or spades, rakes, forks, hoes, scrapers, brooms or other long handled construction tools, simply are a single straight shaft with the tool head attached at one end that require an inline grip for use. The gripping end of the tool handle typically comprises nothing more than the end of the handle shaft. This type of handle is not ergonomically beneficial in maintaining a more natural or neutral grip during use. During use of the tool, the gripped end may become slippery or sweaty and cause formation of blisters and/or calluses on a user's hands and fingers from the undue stress and strain in trying to maintain a grip. Moreover, the grip necessitated by this tool handle configuration causes significant rotation of at least the wrist, elbow and shoulder and bending at the waist causing undue stress and strain on these joints and the back.

Tool handles have been modified to provide more accommodating grips. U.S. Pat. No. 8,032,991 discloses a short handle for a pry bar with a grip utilizing thumb receiving recesses for both right and left handed gripping. U.S. Pat. No. 8,036,577 discloses a tool handle for a socket wrench with a bulb-shaped rounded gripping end sized to contain a small storage unit therein. U.S. Publication No. 2008/0092337 discloses a tool handle for surgical tools that has an outer gripping surface which is defined by three longitudinal convexly contoured side surfaces. However, while these modifications are claimed to be ergonomic, none embody a grip with an ergonomic configuration that remedies the additional problem of rotational stress to the wrist, elbow and shoulder caused while gripping the tool handle with the non-lifting hand.

Thus, there is a recognized need in the art for improvements in ergonomic tool handle grips that are lightweight and are acceptable to a user. Specifically, the prior art is deficient in an ergonomic tool handle grip having an ergonomic configuration and gripping portion that comfortably accommodates the palm and fingers of the user in a non-slip manner during use. The present invention fulfills this long-standing need and desire in the art.

### SUMMARY OF THE INVENTION

The present invention is directed to a device for hand-gripping a tool handle. The device comprises, on an elongate gripping body, a means for receiving a gripping end of a tool handle and a means for gripping the gripping end thereof.

The present invention also is directed to a tool handle grip having an elongate body. The tool handle grip has a receiving end with an inner diameter greater than an outer diameter of a gripping end of a tool handle, a knob gripping end opposite to the receiving end; and a gripping portion with a gripping surface disposed thereon inclining upwardly from the receiving end and the gripping knob end. The receiving end, knob gripping end and gripping portion form an elongate S-like curved shape. In a related invention, the device receiving end further comprises one or two threaded engagement points disposed thereon and one or two threaded fasteners configured to threadably engage the engagement points. In another related invention, the device comprises, in combination, a tool handle received within the receiving end of the tool handle grip.

The present invention is directed further to a tool handle grip and tool handle assembly. The assembly comprises a tool handle having a gripping end and a work end and, on an elongate body, a tool handle receiving end slidably engaged with the tool handle gripping end and a knob gripping end. The receiving end and the knob gripping end comprise respective ends of a gripping portion that form an elongate inclined S-like curve along the elongate body. In a related invention the receiving end of the assembly further comprises one or two threaded engagement points disposed thereon, said tool handle gripping end secured within the receiving end via one or two threaded fasteners threadably engaged therewith through the one or two threaded engagement points. In another related invention the assembly further comprises a tool head affixed to the work end of the tool handle.

Other and further aspects, features, and advantages of the present invention will be apparent from the following description of the presently preferred embodiments of the invention. These embodiments are given for the purpose of disclosure.

### BRIEF DESCRIPTIONS OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIG. 1A is a right side perspective view of the tool handle grip.

FIG. 1B is a left side perspective view of the tool handle grip.

FIG. 2A is a top plan view of the tool handle grip.

FIG. 2B is a bottom plan view of the tool handle grip.

FIG. 3A is a partial perspective view of the front and right side view of the tool handle grip particularly depicting the receiving end of the tool handle grip.

FIG. 3B is a partial perspective view of the front and right side view of the tool handle grip particularly depicting an alternate embodiment of FIG. 3A illustrating a threaded receiving end of the tool handle grip.

FIG. 3C is a partial perspective view of the back and right side view of the tool handle grip.

FIG. 4A is a right side plan view of a tool handle and grip assembly attached to a spade toolhead.

FIG. 4B illustrates representative dimensions of the assembly of FIG. 4A.

### DETAILED DESCRIPTION OF THE INVENTION

As used herein the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value, e.g., having the same function or result. In some instances, the term “about” may include numerical values that are rounded to the nearest significant figure.

As used herein, the terms “right” and “left” are from the perspective of a user gripping the tool handle grip and looking along the tool handle to the tool head.

In one embodiment of the present invention there is provided a device for hand-gripping a tool handle, comprising on an elongate gripping body, means for receiving a gripping end of a tool handle; and means for gripping the gripping end thereof.

In an aspect of this embodiment the receiving means may comprise a receiving end having an inner diameter greater than an outer diameter of the gripping end of the tool handle. Further to this particular aspect the receiving end comprises one or two threaded engagement points disposed thereon configured to threadably receive one or two threaded fasteners. In both aspects the receiving end may comprise a threaded inner surface.

In another aspect the gripping means may comprise a knob gripping end opposite to the receiving end on the elongate body and a gripping portion disposed between the receiving end and the gripping knob end. In this aspect the gripping knob end may comprise a knob component having a plurality of finger grooves formed around an outer perimeter thereof and a back grip portion disposed on and raised from a back surface of the knob component. Also, in this aspect the gripping portion may be disposed between the receiving end and the knob end along the elongate gripping body, where the gripping portion has a gripping surface comprising in an ergonomic relationship a raised thumb grip formed on an upper surface near the receiving end; raised side grips extending laterally along right and left sides thereof; and a plurality of finger grooves formed along a lower surface thereof in alignment with the side grips. Particularly, gripping portion inclining upwardly from the knob gripping end to the receiving end such that the elongate body has an elongate S-like curved shape.

In another embodiment of the present invention there is provided a tool handle grip having an elongate body, comprising a receiving end with an inner diameter greater than an outer diameter of a gripping end of a tool handle; a knob gripping end opposite to the receiving end; and a gripping portion with a gripping surface disposed thereon inclining upwardly from the receiving end and the gripping knob end, where the receiving end, knob gripping end and gripping portion form an elongate S-like curved shape. Further to this embodiment the tool handle grip further comprises, in combination, a tool handle received within the receiving end of the tool handle grip.

In both embodiments the receiving end further may comprise one or two threaded engagement points disposed thereon and one or two threaded fasteners configured to threadably engage the engagement points. Also, the receiving end may comprise a threaded inner surface. Also, in both embodiments the gripping knob end may comprise a plurality of finger grooves formed around an outer perimeter of a knob component and a back grip portion disposed on and raised from a back surface of the knob component. In addition the gripping portion may comprise on the gripping surface a raised thumb grip, raised side grips in appositional relationship and a plurality of finger grooves all disposed thereon in an ergonomic gripping relationship.

In yet another embodiment of the present invention there is provided a tool handle grip and tool handle assembly, comprising a tool handle having a gripping end and a work end; and on an elongate body, a tool handle receiving end slidably engaged with the tool handle gripping end and a knob gripping end, where the receiving end and the knob gripping end comprise ends of a gripping portion that forms an elongate inclined S-like curve along the elongate body. Further to this embodiment the assembly comprises a tool head affixed to the work end of the tool handle.

In both embodiments the receiving end further may comprise one or two threaded engagement points disposed thereon, where tool handle gripping end secured within the receiving end via one or two threaded fasteners threadably engaged therewith through the one or two threaded engagement points. In an aspect, the receiving end may comprises a threaded inner surface to threadably engage a threaded gripping end of the tool handle.

In both embodiments, the gripping knob end of the assembly may comprises a plurality of finger grooves formed around an outer perimeter of a knob component and a back grip portion disposed on and raised from a back surface of the knob component. In addition the gripping portion of the assembly may comprise, in an ergonomic gripping relationship, a raised thumb grip formed on an upper surface near the receiving end, raised side grips extending laterally along right and left surfaces thereof and a plurality of finger grooves formed along a lower surface thereof in alignment with the side grips.

Provided herein is an ergonomically designed grip for a tool handle for tools, such as, but not limited to, shovel, spade, scraper, fork, hoe, rake or broom heads or construction tool heads. The ergonomics of the grip design are such that both a right-handed or a left-handed user has a comfortable and supportive surface by which to grasp and hold the grip with the palm and fingers. Moreover, the tool handle grip described herein enables a user to wield a particular tool without the rotational stress to the wrist, elbow and/or shoulder caused by standard inline gripping of tool handles. The tool handle grip provides for a more normal or neutral orientation of the wrist, elbow and shoulder in relation to the torso during use. The tool handle grip is durable, reliable in use, injection-molded from standard materials and easily secured to a tool handle.

Generally, the tool handle grip comprises an elongate curved body with means for gripping the tool handle grip and means for receiving the gripping end of the tool handle. Particularly, a receiving end is provided that is configured to slidably, optionally threadably, receive the tool handle. The tool handle grip may be secured or fastened to the tool handle via one or two screws or other threaded fastening means, as are known and standard in the art, through the receiving end of the grip.

Opposite to the receiving end of the tool handle grip is a gripping end comprising a knob with finger grooves around the outer circumference and a back grip portion. A curved gripping portion is formed between the knob gripping end and the receiving end. The gripping portion comprises a thumb grip, side grips and finger grooves. A user grips the gripping knob with one hand such that the fingers are positioned in the finger grooves and the palm is positioned against the back grip portion and wraps the other hand around the gripping portion such that the fingers are accommodated in the finger grooves, the thumb is positioned on the thumb grip and the palm is positioned against one of the side grips, depending on which hand is used.

The thumb grip and finger grooves prevent hand slippage. The back and side grips cushion the palms of the respective hands. Particularly, the back grip protects the palm when a user exerts a downward force on the tool handle. Moreover, the gripping knob enables a user to exert a greater downward force and enables greater leverage when working with the tool.

The tool handle grip may be formed by an injection molding process as is known and standard in the art. For example the tool handle grip body, including the finger grooves, may comprise a molded thermoplastic or foam material. For example, the thermoplastic may comprise polypropylene, low-density polyethylene (LDPE), high-density polyethylene (HDPE), polypropylene copolymerized with ethylene. Representative examples of the foam or gel material include, but are not limited to, silica gel. The side, thumb and back grips disposed on the surface of the gripping portion may comprise a gel, foam or other acceptable compressible and conformable material.

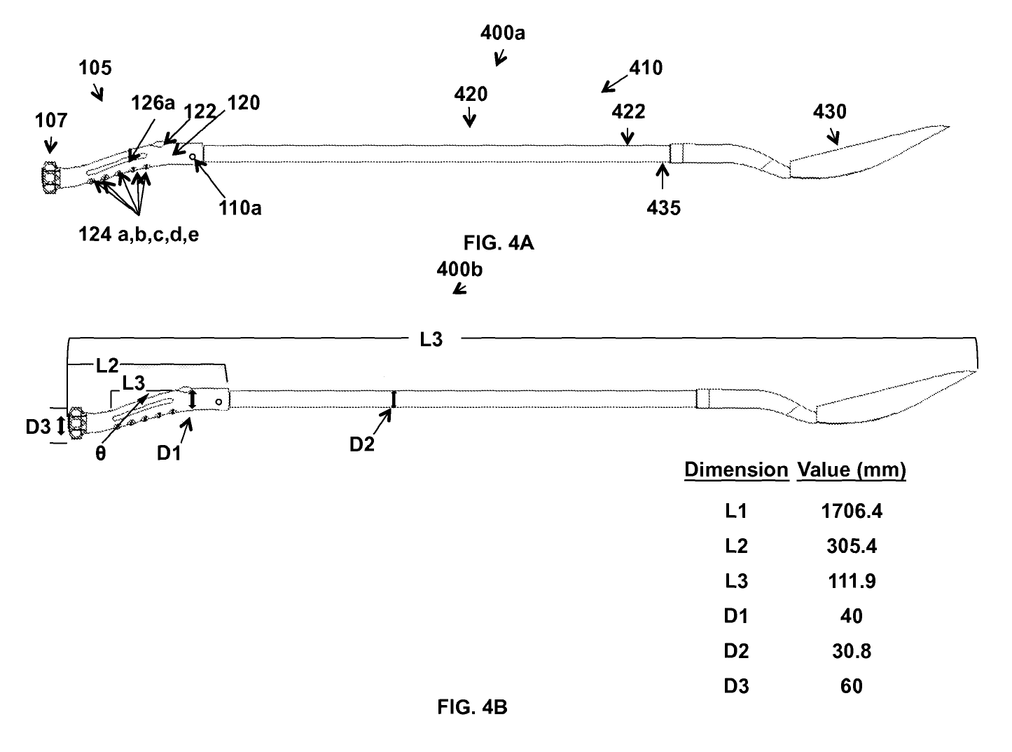

The tool handle grip has dimensions to accommodate the grip of an average user, but can be varied to accommodate large and petite hands The tool handle has a substantially oval shape in cross-section with a single axis of symmetry. The substantially oval shape is configured to fit a wide range of hand sizes. The tool handle can be elongated along the x-axis. For example, as per FIG. 4B, L2 is about 203 mm to about 4.06 mm and/or L3 is about 76 mm to about 152 mm depending on the tool use. See FIG. 4B for other representative dimensions. Moreover, the side, thumb and back grips may be adjusted to accommodate a softer or harder grip or different hand sizes.

The tool handle grip is configured to receive any tool handle to form an assembly thereof. For example, the tool handle may be a single piece solid or hollow construction or may be an assemblage of a working component pieces and a gripping component piece attached via known and standard means. The tool handle may be constructed from known materials such as wood, fiberglass, plastic or a tubular material, e.g., steel or aluminum tubing, traditionally used in the manufacture of handles for garden and lawn tools or for construction tools. When assembled with the tool handle grip, the tool handle may comprise a tool head attached to the work end of the tool handle or the tool handle can receive and attach a tool head at the work end thereof after assembly with the tool handle grip.

The tool handle, depending on the material, may comprise one or two threaded engagement points that align with the threaded engagement point(s) on the receiving end of the tool handle grip. The tool handle also may have a threaded gripping end to engage with a threaded receiving end of the tool handle grip with or without the further threaded securing means.

In use, the tool handle grip provides the advantages of an ergonomic grip allowing the wrist, elbow and shoulder to maintain a more neutral position than possible with an inline grip on a straight tool handle shaft. In gripping both the knob gripping end and the gripping portion with both hands, a user has more control over the tool head attached to the work end of the tool handle during digging, lifting, scraping, sweeping or motions required by a construction tool or any other motions necessary to properly use the tool.

For example, the design of the knob gripping end and the gripping portion of tool handle grip stabilizes the fingers and palm so that they do not slip down the tool handle shaft during digging or other use, as would occur with an inline grip and lessens significantly supination of the wrist and rotation of the shoulder. Moreover, in use the tool handle grip provides increased control against torsional force that causes a tool head, e.g., a shovel, to rotate or roll about the handle when lifting a load, particularly an unevenly distributed load, thereby spilling.

As described below, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

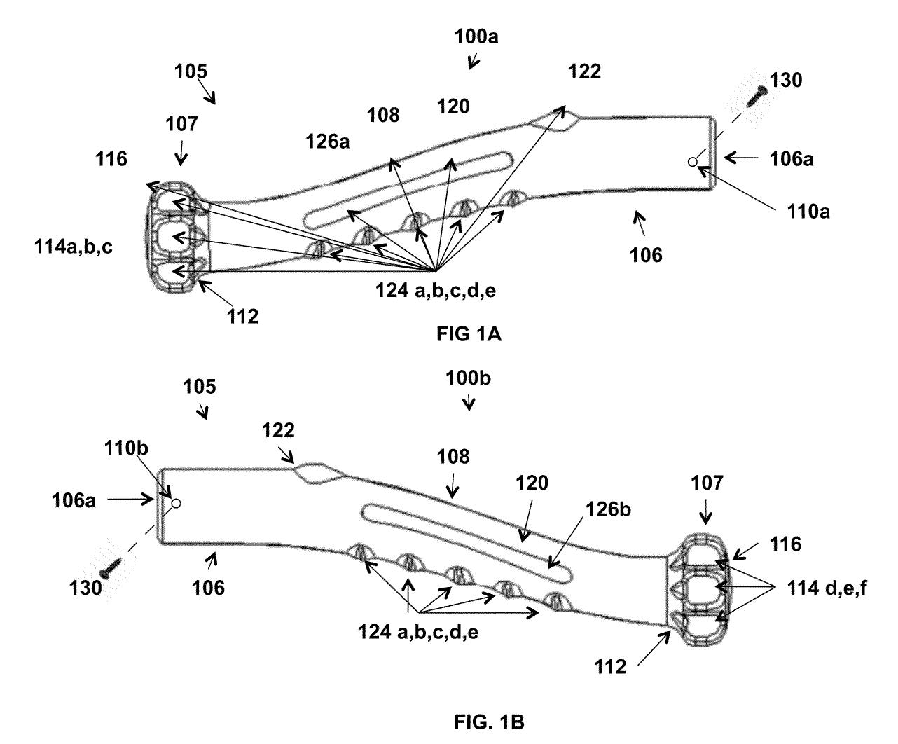

FIGS. 1A and 1B are considered jointly and depict right and left side views 100a, 100b. The right and left views are mirror images, thus the tool handle grip can be gripped easily by either a right- or a left-handed user of the tool. The tool handle grip 105 comprises a tool handle receiving means 106, a knob gripping end 107, and a gripping means 108. The tool handle grip is substantially cylindrical in shape. The handedness of the user determines which hand grips the knob gripping end and which hand grips the gripping means. That is, a right-handed user would grip the knob gripping end with the right hand and the gripping means with the left hand and a left-handed user would do the opposite.

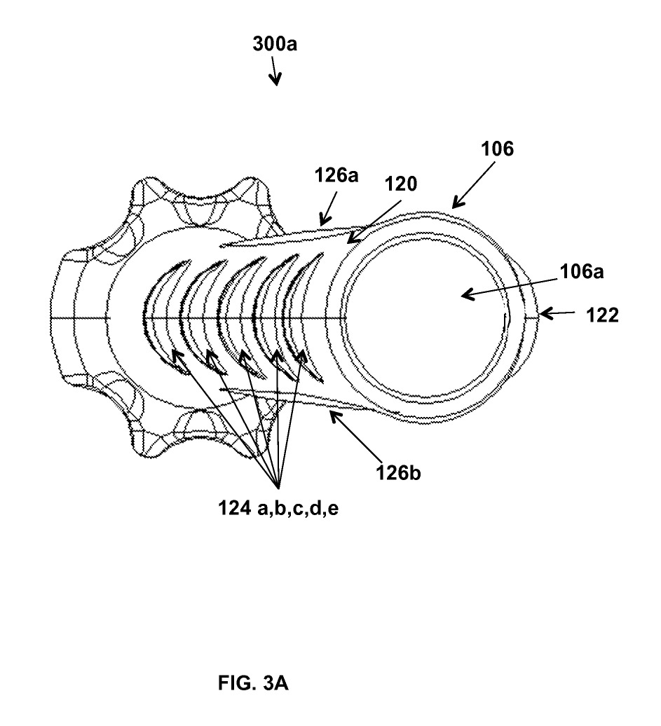

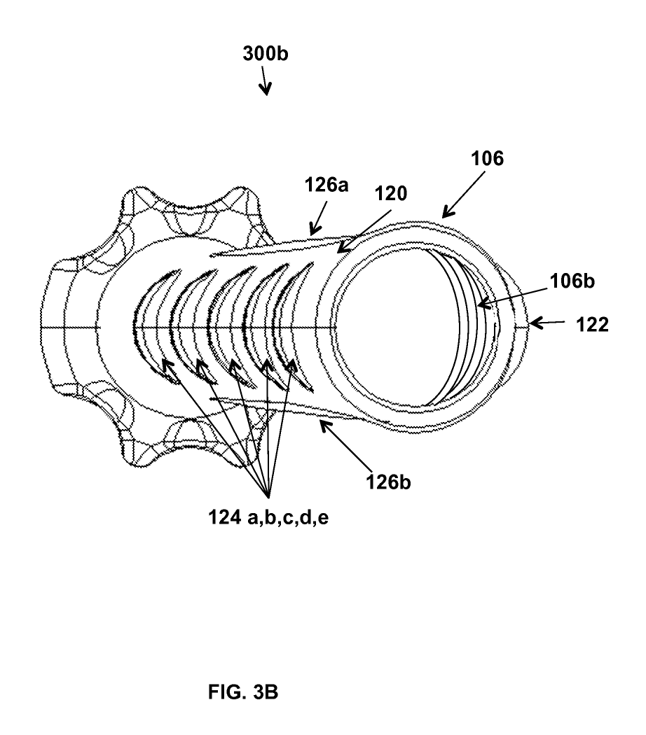

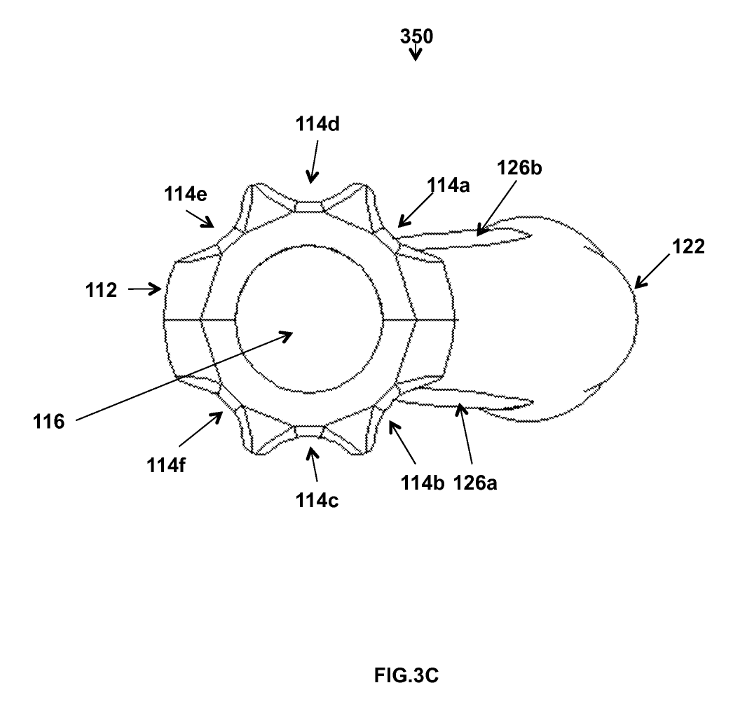

The tool handle grip receiving means comprises a receiving end 106a having a female internal cylindrical-like configuration to slidably receive the gripping end of a tool handle therein (see FIG. 3A). A threaded engagement point 110a, b is disposed on the outer surface of the receiving end on one or both of the right or left sides thereof to threadably receive a screw 130 or other threaded fastener, as is known in the art, therethrough to secure A tool handle within the receiving end.

The knob gripping end 107 comprises substantially circular front and back surfaces that form a knob component 112 therebetween. The knob component has a plurality of finger grooves 114a,b,c,d,e,f of a convex shape that are formed from and evenly distributed along the right 114a,b,c and the left 114d,e,f halves of the outer perimeter of the knob component and has a back grip 116 formed on the back surface of the knob component. The back grip is slightly raised from the back surface of the knob gripping end to provide support and cushioning for the palm of the hand gripping the knob component (see FIG. 3B).

The gripping means 108 comprises a gripping surface 120 disposed between the knob gripping end 107 and the receiving end 106 of the tool handle grip 105. The gripping surface is configured as an elongated S-like curve between the receiving end and the knob gripping end of the tool handle grip. The upper and lower portions of the gripping surface curve or incline upwardly from the knob end to the receiving end such than an acute angle is formed (see FIG. 4B).

The gripping surface 120 comprises a thumb grip 122 disposed on and raised from the upper portion of the gripping surface proximate to the receiving end 106 of the tool handle grip 105. The lower portion of the gripping surface has finger grooves 124a,b,c,d,e formed thereon along the incline. The fifth finger groove enables a user to grip the tool handle grip 105 closer to or farther from the knob gripping end 107 to accommodate a smaller or larger hand and/or to maximize a comfortable grip. The tool handle grip may be constructed with only four finger grooves or with more than five finger grooves, for example, six or seven, to provide more positional choices for a user to achieve better leverage and control during use of the tool.

The gripping surface 120 further comprises a pair of elongated side grips 126a,b oppositely disposed on and raised from the right and left sides of the gripping surface. The side grips are formed along the length of the incline on the gripping surface and are positioned such that when a user has a hand clasped around the gripping surface with the fingers placed in four of the finger grooves, the palm of the hand naturally lies on one of the side grips 126a,b and the thumb naturally extends to the thumb grip 122. Thus, the palm of the hand and the fingers are simultaneously and comfortably accommodated when the tool handle grip 105 is gripped by a user. It is contemplated that the side grips may be shorter or longer, as necessary, to fit on a shorter or longer tool handle grip insofar as the positioning of the thumb grip and finger grooves are adjusted accordingly, as necessary.

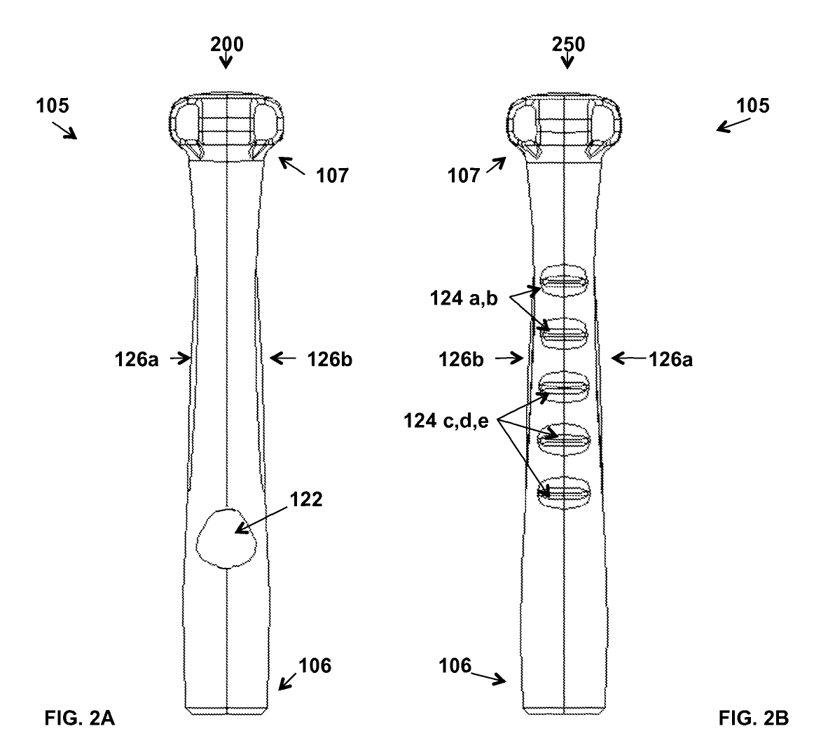

With continued reference to FIGS. 1A and 1B, FIGS. 2A and 2B depict top 200 and bottom 250 views of the tool handle grip 105. In FIG. 2A one is better able to visualize how the thumb grip 122 is disposed on the upper portion of the gripping surface 120 in relation to the knob gripping end 107 and the side grips 126a,b. It is evident that the thumb grip can accommodate either a right-handed or left-handed user. Concomitantly, in FIG. 2B one is better able to visualize the disposition of the finger grooves 124a,b,c,d,e in relation to the knob gripping end 107 and the side grips 126a,b. Particularly, it is evident that the finger grooves align with the side grips along the length of the tool handle grip and are of sufficient width to accommodate either a right-handed or a left-handed user. When viewed together, FIGS. 2A and 2B demonstrate how the thumb grip is positioned forward of the finger grooves and side grips

With continued reference to any of the previous figures, FIGS. 3A, 3B and 3C depict partial, truncated front, bottom and rear, side views 300a, 300b and 350 of the tool handle grip 105. Although not to scale, the dispositions of the thumb grip 122 and the side grips 124a,b are indicated in each view. Moreover, the receiving end 106 is shown in a truncated format in views 300a and 300b and are intended to show, in a cross-section, that the opening in the receiving end may 106a or may not 106b be threaded.

View 300a provides a front view of the finger grooves 124a,b,c,d,e disposed along the bottom surface of the tool handle grip 105 and the receiving end opening 106a configured to slidably receive the gripping end of a tool handle. The view is rotated such that the bottom portion of the gripping surface 120 is shown at the side. View 300b, depicts an alternative embodiment of the receiving end of the tool handle grip 105. The receiving end 106 may comprise a female threaded configuration 106b to receive a threaded gripping end of a tool handle. In this alternate configuration, the tool handle may or may not be additionally secured with the threaded screw 130 or other fastening means as depicted in FIGS. 1A and 1B.

View 350 provides a rear view of the knob component 112 of the knob gripping means 107. The view is rotated such that the left side of the gripping surface 120 is shown at the top. One is better able to visualize the back grip 116 formed on the back surface of the knob component 112. Moreover, the view illustrates the symmetrical disposition of the finger grooves 114a,b,c on the right side of the knob component and of the finger grooves 114d,e,f on the left side of the knob component. The symmetrical positioning of six finger grooves enables a user to select which finger grooves in which to position the fingers to maximize a comfortable ergonomic grip. The knob component, as with the gripping portion, may be constructed with fewer or greater finger grooves for alternative positional choices. Although not to scale, the dispositions of the thumb grip 122 and the side grips 126a,b are indicated in each view. The knob gripping means may be formed to have a larger or smaller diameter across the back surface thereof to accommodate a larger or smaller hand.

With continued reference to any of the preceding figures, FIGS. 4A and 4B are perspective views 400a and 400b of an assembled tool 410. In FIG. 4A, the tool comprises a tool handle 420 having a work end 422 and a gripping end 424. A tool head 430 is attached at 435 to the work end of the tool handle and the tool handle grip 105 is attached at one of the threaded engagement points 110a,b to the gripping end of the tool handle. The view shows the disposition of the thumb 122 and side 126a,b grips and the finger grooves 124a,b,c,d,e on the gripping surface 120 and the knob gripping end 107 in relation to the gripping surface of the tool handle grip 105.

FIG. 4B shows the same view as FIG. 4A and illustrates representative dimensions of the assembled tool, including overall length L1 of the assembled tool, the overall length of the tool handle grip L2 and the length L3 of the incline comprising the gripping surface of the tool handle as measured along the axis of the tool handle. An acute angle θ of about 10 degrees to about 40 degrees is formed along L3 (see FIG. 4B) between the thumb grip and the knob gripping end. Also, the diameter D1 of the receiving end and the diameter D2 of the gripping end of the tool handle and the outer diameter D3 of the knob component of the tool handle grip are provided. The dimensions of the assembled tool and of the tool handle grip and tool handle assembly are not limited to those disclosed herein. Generally, the dimensions of the tool handle grip may be scaled up or down to accommodate larger or smaller users and may even be customized for a particular user. For example, the finger grooves can be about 10 mm to about 30 mm to accommodate a variety of finger sizes. The outer diameter of the knob component is about 50 mm to about 127 mm to fit a wide range of palm hand sizes. The back grip portion diameter is constrained by the outer diameter of the knob component.

Any patents or publications mentioned in this specification are indicative of the levels of those skilled in the art to which the invention pertains. Further, these patents and publications are incorporated by reference herein to the same extent as if each individual publication was specifically and individually incorporated by reference.

One skilled in the art will readily appreciate that the present invention is well adapted to carry out the objects and obtain the ends and advantages mentioned, as well as those inherent therein. It will be apparent to those skilled in the art that various modifications and variations can be made in practicing the present invention without departing from the spirit or scope of the invention. Changes therein and other uses will occur to those skilled in the art which are encompassed within the spirit of the invention as defined by the scope of the claims.

What is claimed is:

1. Device for hand-gripping a tool handle, comprising:
on an elongate gripping body, means for receiving a gripping end of a tool handle; and
means for gripping the gripping end thereof.

2. The device of claim 1, said receiving means comprising a receiving end having an inner diameter greater than an outer diameter of the gripping end of the tool handle.

3. The device of claim 2, said receiving end further comprising one or two threaded engagement points disposed thereon configured to threadably receive one or two threaded fasteners.

4. The device of claim 1, said gripping means comprising:
a knob gripping end opposite to the receiving end on the elongate body; and
a gripping portion disposed between the receiving end and the gripping knob end.

5. The device of claim 4, wherein the gripping knob end comprises:
a knob component having a plurality of finger grooves formed around an outer perimeter thereof; and
a back grip portion disposed on and raised from a back surface of the knob component.

6. The device of claim 4, wherein the gripping portion is disposed between the receiving end and the knob end along the elongate gripping body, said gripping portion having a gripping surface comprising in an ergonomic relationship:
a raised thumb grip formed on an upper surface near the receiving end;
raised side grips extending laterally along right and left sides thereof; and
a plurality of finger grooves formed along a lower surface thereof in alignment with the side grips.

7. The device of claim 4, said gripping portion inclining upwardly from the knob gripping end to the receiving end such that the elongate body has an elongate S-like curved shape.

8. The device of claim 7, wherein the elongate S-like curved shape comprises an acute angle of about 20 degrees to about 40 degrees with the receiving end and the knob gripping end.

9. A tool handle grip having an elongate body, comprising:
a receiving end with an inner diameter greater than an outer diameter of a gripping end of a tool handle;
a knob gripping end opposite to the receiving end; and
a gripping portion with a gripping surface disposed thereon inclining upwardly from the receiving end and the knob gripping end, said receiving end, knob gripping end and gripping portion forming an elongate S-like curved shape.

10. The tool handle grip of claim 9, said receiving end further comprising one or two threaded engagement points disposed thereon; and
one or two threaded fasteners configured to threadably engage the engagement points.

11. The tool handle grip of claim 9, wherein the knob gripping end comprises:
a plurality of finger grooves formed around an outer perimeter of a knob component; and
a back grip portion disposed on and raised from a back surface of the knob component.

12. The tool handle grip of claim 9, wherein the gripping portion comprises on the gripping surface a raised thumb grip, raised side grips in appositional relationship and a plurality of finger grooves all disposed thereon in an ergonomic gripping relationship.

13. The tool handle grip of claim 9, wherein the elongate S-like curved shape comprises an acute angle of about 20 degrees to about 40 degrees with the receiving end and the knob gripping end.

14. The tool handle grip of claim 9, further comprising in combination a tool handle received within the receiving end of the tool handle grip.

15. A tool handle grip and tool handle assembly, comprising:
a tool handle having a gripping end and a work end; and
on an elongate body, a tool handle receiving end slidably engaged with the tool handle gripping end and a knob gripping end, said receiving end and knob gripping end comprising ends of a gripping portion that forms an elongate inclined S-like curve along the elongate body.

16. The assembly of claim 15, wherein the receiving end further comprises one or two threaded engagement points disposed thereon, said tool handle gripping end secured within the receiving end via one or two threaded fasteners threadably engaged therewith through the one or two threaded engagement points.

17. The assembly of claim 15, wherein the knob gripping end comprises:
a plurality of finger grooves formed around an outer perimeter of a knob component; and
a back grip portion disposed on and raised from a back surface of the knob component.

18. The assembly of claim 15, wherein the gripping portion comprises in an ergonomic gripping relationship:
a raised thumb grip formed on an upper surface near the receiving end;
raised side grips extending laterally along right and left surfaces thereof; and
a plurality of finger grooves formed along a lower surface thereof in alignment with the side grips.

19. The assembly of claim 15, wherein the elongate S-like curved shape comprises an acute angle of about 20 degrees to about 40 degrees with the receiving end and the knob gripping end.

20. The assembly of claim 15, further comprising a tool head affixed to the work end of the tool handle.
